(19) United States
(12) Patent Application Publication
(10) Pub. No.: US 2014/0208242 A1
(43) Pub. Date: Jul. 24, 2014

(54) METHOD FOR GENERATING EMOTIONAL NOTE BACKGROUND

(71) Applicant: Huawei Technologies Co., Ltd., Shenzhen (CN)

(72) Inventor: Xinxin Wu, Shenzhen (CN)

(73) Assignee: Huawei Technologies Co., Ltd., Shenzhen (CN)

(21) Appl. No.: 14/145,664

(22) Filed: Dec. 31, 2013

Related U.S. Application Data
(63) Continuation of application No. PCT/CN2013/080822, filed on Aug. 5, 2013.

(30) Foreign Application Priority Data
Jan. 22, 2013 (CN) 201310023396.7

(51) Int. Cl. G06F 3/0484

(52) U.S. Cl. CPC G06F 3/0484
USPC 715/762

(57) ABSTRACT

Embodiments of the present invention provide a method for generating an emotional note background. The method includes: acquiring user environment information; generating a dynamic environment background according to the user environment information, and receiving user input information; and adjusting the dynamic environment background gradually and dynamically according to the user input information to obtain an emotional note background. The embodiments of the present invention, by acquiring user environment information intelligently to generate a colorful background automatically, performing real-time analysis on user input information, and adjusting the background gradually and dynamically to create a lively note background for a user, implement an exchange and an interaction between an originally monotonous background and the user, thereby meeting more personalized requirements and emotional requirements of the user.

### CROSS-REFERENCE TO RELATED APPLICATIONS

This application is a continuation of International Application No. PCT/CN2013/080822, filed on Aug. 5, 2013, which claims priority to Chinese Patent Application No. 201310023396.7, filed on Jan. 22, 2013 both of which are hereby incorporated by reference in their entireties.

### TECHNICAL FIELD

The present invention relates to the field of communications technologies, and in particular, to an emotional note background.

### BACKGROUND

With the popularity of electronic devices and handheld terminal devices, more and more people begin to record life events and keep up correspondence by using electronic devices. In addition, people have increasingly high requirements for diversified and personalized record carrier backgrounds, especially for a log background, a mail background, and the like.

Currently, for various note backgrounds, several sets of built-in default backgrounds are provided for a user to select and switch manually, or a function of adding a background manually is provided for a user to add a background manually. In the technical solution, because a limited quantity of built-in backgrounds is used, there is a significant limitation in diversified background patterns, thereby failing to meet more personalized requirements and emotional requirements of a user. In addition, the user has to select a background manually, which increases a complexity in operation steps and application of the user, thereby reducing user experience.

### SUMMARY

Embodiments of the present invention provide a method for generating an emotional note background, which, by acquiring user environment information intelligently to generate a colorful background automatically, performing real-time analysis on user input information, and adjusting the background gradually and dynamically to create a lively recording environment for a user, implements an exchange and an interaction between an originally monotonous background and the user and effectively resolves a significant limitation in diversified background patterns due to a limited quantity of built-in backgrounds, thereby meeting more personalized requirements and emotional requirements of the user.

An embodiment of the present invention provides a method for generating an emotional note background, including:
acquiring user environment information;
generating a dynamic environment background according to the user environment information;
receiving user input information; and
adjusting, according to the user input information, the dynamic environment background gradually and dynamically to obtain an emotional note background.

The user environment information includes any one of the following information or a combination of multiple pieces of the following information: system date, system time, and current weather information.

The generating the note background according to the user environment information includes: performing image processing on the user environment information according to a preset image processing method, and displaying an image background on a new note page of the user to obtain the note background.

The adjusting, according to the user input information, the dynamic environment background gradually and dynamically to obtain an emotional note background includes:
extracting a key word from the user input information; and
performing image processing on the key word according to the preset image processing method, and integrating an image of the key word into the note background to generate an emotional note background.

An embodiment of the present invention provides an apparatus for generating an emotional note background, including:
an acquiring module, configured to acquire user environment information;
a generating module, configured to generate a dynamic environment background according to the user environment information and by using a preset image processing method;
a receiving module, configured to receive user input information;
where the generating module is further configured to extract a key word from the user input information, and perform image processing on the key word by using the preset image processing method;
an integrating module, configured to integrate an image of the keyword into the dynamic environment background to generate an emotional note background.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for generating an emotional note background according to an embodiment of the present invention; and

FIG. 2 is a schematic diagram of an apparatus for generating an emotional note background according to an embodiment of the present invention.

### DETAILED DESCRIPTION

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

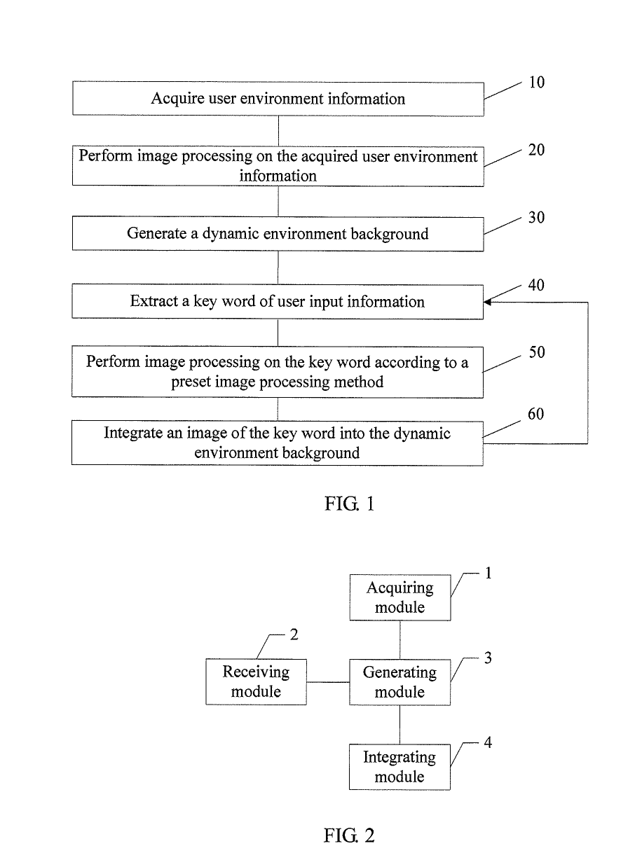

FIG. 1 is a schematic flowchart of a method for generating an emotional note background according to an embodiment of the present invention. As shown in FIG. 1, the method includes the following steps:

S10. Acquire user environment information.

The user environment information may include any one of the following information or a combination of multiple pieces of the following information: system date, system time, and weather information, which, however, is not limited thereto. In a specific implementation process of this embodiment, when a user creates a note page, a system enters the note page. At this time, the system automatically reads current system date and system time, and acquires current weather information online, for example, acquires [2012-8-1 11:21, cloudy, 30 degrees Celsius/23 degrees Celsius, breeze].

Specifically, the note page may be a terminal log, a network log, a mail, or the like.

S20. Perform image processing on the acquired user environment information.

Image processing is performed according to the acquired user environment information and by using a preset image processing method. In a specific implementation process of this embodiment, for example, when the current weather information is [Cloudy, 30 degrees Celsius/23 degrees Celsius, breeze], the system invokes an image resource corresponding to cloudy from a picture resource library of a server, and displays the image resource on the background; then, the system determines what the current season is according to the temperate range [30 degrees Celsius/23 degrees Celsius] and the date; if it is a hot summer day, the system may add corresponding summer elements to the background, for example, a hot road, and the like, and then control a dynamic drifting speed of cloud according to the [breeze].

S30. Generate a dynamic environment background.

In the specific implementation process of this embodiment, the system displays a background of a dynamic environment image on a new note page of the user; after the user clicks the new note page, a dynamic environment background that includes system date, system time, and current real-time weather is generated immediately for the user.

S40. Extract a key word of user input information.

The user input information may be specifically note information input by the user. In the specific implementation process of this embodiment, after the user inputs a note content, the system gradually collects the content input by the user, and extracts a key word of the input content according to a preset method for extracting a key word. For example, the user inputs the following content: [Today, my grandmother and I buy a sunflower on the road. When we come back home, I get a long bottle and place the sunflower in the bottle. Petals of the sunflower are golden yellow; the sunflower has very big green leaves and a thick green stem. Teacher Li once said: “A sunflower is formed by petals in all directions.” The sunflower is an annual herb, with the flowers in the shape of a plate. The sunflower seeds are eatable and can also be squeezed into oils. The petals of the sunflower revolve around the sun every day, which is the origin of the name sunflower.]. Through statistical analysis of the content, the system finds that the user mentions the key word [sunflower] several times and the content always describes the key word. Therefore, the system extracts, according to the preset method for extracting a key word, the key word [sunflower] during the user input.

S50. Perform image processing on the key word according to a preset image processing method.

In the specific implementation process of this embodiment, the image processing means that, for example, when the extracted key word is “sunflower”, the system invokes a picture including a sunflower from the picture resource library.

S60. Integrate an image of the key word into the dynamic environment background.

In the specific implementation process of this embodiment, the image of the key word may be a sunflower picture invoked from the picture resource library of the server, and the sunflower picture is loaded to the previous existing dynamic environment background, so that when the user inputs log contents, the dynamic background varies dynamically with the input contents of the user.

FIG. 2 is a schematic diagram of an apparatus for generating an emotional note background according to an embodiment of the present invention. As shown in FIG. 2, the apparatus includes an acquiring module 1, a receiving module 2, a generating module 3, and an integrating module 4, where:

The acquiring module 1 is configured to acquire user environment information. Specifically, the user environment information may include any one of the following information or a combination of multiple pieces of the following information: system date, system time, and weather information, but the user environment information is not limited thereto.

The generating module 3 is configured to generate a dynamic environment background according to the user environment information and by using a preset image processing method.

The receiving module 2 is configured to receive user input information.

The generating module 3 is further configured to extract a key word from the user input information, and perform image processing on the key word by using the preset image processing method.

The integrating module 4 is configured to integrate an image of the keyword into the dynamic environment background to generate an emotional note background.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some or all the technical features thereof, without departing from the spirit and scope of the technical solutions of the embodiments of the present invention.

What is claimed is:

1. A method for generating an emotional note background, the method comprising:
acquiring user environment information;
generating a dynamic environment background according to the user environment information;
receiving user input information; and
adjusting, according to the user input information, the dynamic environment background gradually and dynamically to obtain an emotional note background.

2. The method for generating an emotional note background according to claim 1, wherein the user environment information comprises at least one of the following information: system date, system time, or current weather information.

3. The method for generating an emotional note background according to claim 1, wherein generating a dynamic environment background according to the user environment information comprises:
performing image processing on the user environment information according to the user environment information and by using a preset image processing method; and
displaying the image background on a user interface to obtain the dynamic environment background.

4. The method for generating an emotional note background according to claim 2, wherein generating a dynamic environment background according to the user environment information comprises:
performing image processing on the user environment information according to the user environment information and by using a preset image processing method; and
displaying the image background on a user interface to obtain the dynamic environment background.

5. The method for generating an emotional note background according to claim 1, wherein adjusting, according to the user input information, the dynamic environment background gradually and dynamically comprises:
extracting a key word from the user input information; and
performing image processing on the key word by using a preset image processing method, and integrating an image of the key word into the dynamic environment background.

6. The method for generating an emotional note background according to claim 5, wherein extracting a key word from the user input information comprises:
extracting a key word according to a word frequency in the user input information.

7. The method for generating an emotional note background according to claim 5, wherein the preset image processing method comprises:
invoking an image corresponding to the key word from a picture resource library.

8. The method for generating an emotional note background according to claim 6, wherein the preset image processing method comprises:
invoking an image corresponding to the key word from a picture resource library.

9. The method for generating an emotional note background according to claim 1, wherein adjusting, according to the user input information, the dynamic environment background gradually and dynamically to generate an emotional note background comprises:
integrating the image of the keyword in the dynamic environment background, wherein the note background varies dynamically with contents input by the user.

10. An apparatus for generating an emotional note background, the apparatus comprising:
an acquiring module, configured to acquire user environment information;
a generating module, configured to generate a dynamic environment background according to user environment information and by using a preset image processing method, extract a key word from the user input information, and perform image processing on the key word by using the preset image processing method;
a receiving module, configured to receive user input information; and
an integrating module, configured to integrate an image of the key word in the dynamic environment background to generate an emotional note background.
